(19) United States
(12) Patent Application Publication
(10) Pub. No.: US 2019/0278979 A1
(43) Pub. Date: Sep. 12, 2019

(54) INFORMATION TRANSMITTING SYSTEM AND METHOD

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventor: CHI-YU CHANG, New Taipei (TW)

(21) Appl. No.: 16/051,028

(22) Filed: Jul. 31, 2018

(30) Foreign Application Priority Data
Mar. 12, 2018 (CN) 201810199246.4

(51) Int. Cl. G06K 9/00

(52) U.S. Cl. CPC G06K 9/00302; G06K 9/00288; G06K 9/00362; G06K 9/00335

(57) ABSTRACT

An information transmitting method to identify information being transmitted while verifying the person giving such information comprises pre-storing feature image of at least one person and expression information corresponding to such feature image. An image of a scene is received and the image is analyzed for containing a preset body part. The preset body part is identified as being one of the feature images when the scene image contains a preset body part and expression information such as interest or non-interest and agreement or non-agreement indicated by the body part or face of the identified person is determined. An information transmitting system is also presented.

### FIELD

The subject matter herein generally relates to information transmitting systems.

### BACKGROUND

Activities such as voting require participants to transmit their decision to an organizer or authority. The participant generally sends the decision through a voting device or a voting application installed on a mobile phone, the participant needs to press a button or icon on the device.

### BRIEF DESCRIPTION OF THE DRAWINGS

Implementations of the present technology will now be described, by way of example only, with reference to the attached figures.

FIG. 1 is a block diagram of an information transmitting system, according to an embodiment.

FIG. 2 is a schematic diagram of the information transmitting system in FIG. 1.

FIG. 3 is a flowchart of an information transmitting method, according to an embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

The term “comprising” means “including, but not necessarily limited to”; it specifically indicates open-ended inclusion or membership in a so-described combination, group, series, and the like.

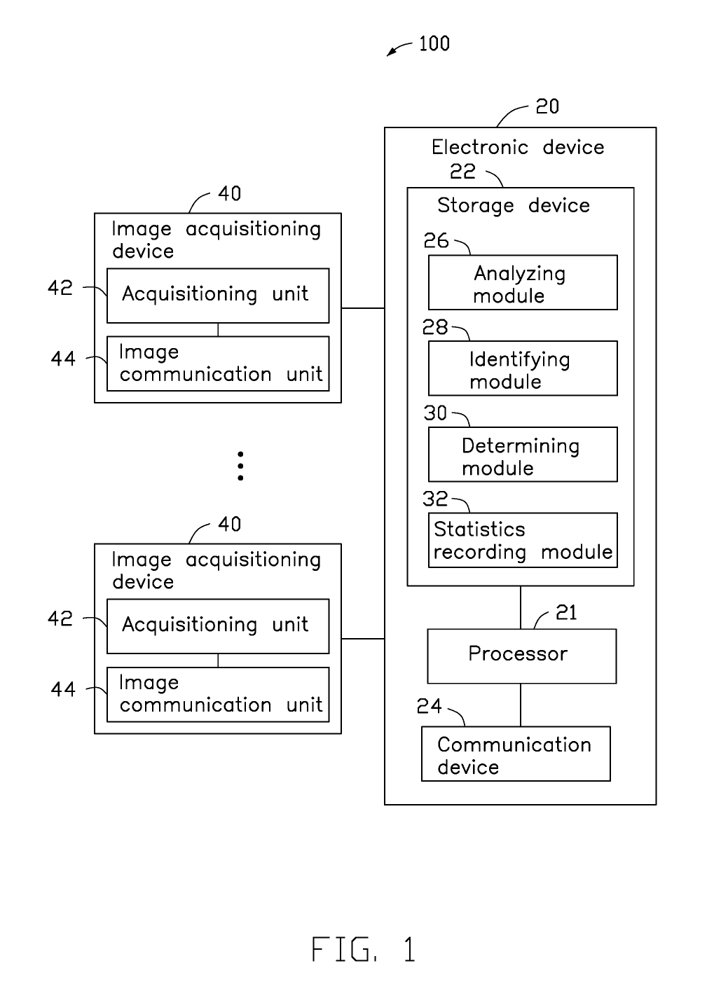

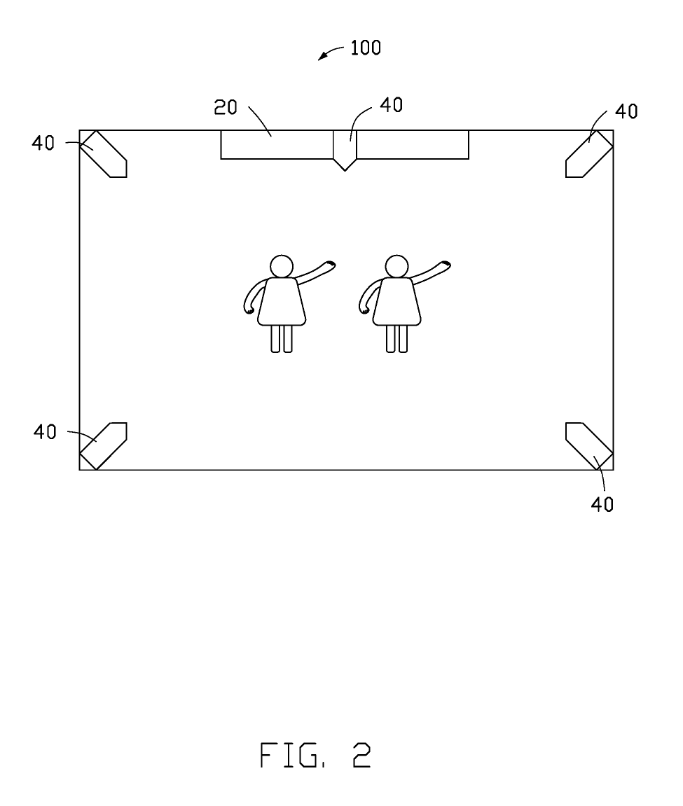

FIGS. 1 and 2 illustrate an information transmitting system 100 applied in a situation where participants need to transmit expression information. The information transmitting system 100 includes an electronic device 20 and at least one image acquisitioning device 40 communicating with the electronic device 20. The image acquisitioning device 40 can be a video camera. The electronic device 20 can be an electronic whiteboard.

The image acquisitioning device 40 includes an image acquisitioning unit 42 and a image communication unit 44. The image acquisitioning unit 42 is configured to capture an image of a scene. The image communication unit 44 is configured to transmit the image of the scene to the electronic device 20. In an embodiment, the information transmitting system 100 includes a number of image acquisitioning devices 40 positioned at different positions to acquire images from different perspectives of the scene. In an embodiment, the information delivery system 100 includes five image acquisitioning devices 40, and one of the image acquisitioning devices 40 is positioned on the electronic device 20.

The electronic device 20 may include, but is not limited to, at least one processor 21, a storage device 22, and a communication device 24. The at least one processor 21, the storage device 22, and the communication device 24 are connected to each other. The storage device 22 stores program codes of function modules in the electronic device 20.

The function modules include an analyzing module 26, an identifying module 28, and a determining module 30. The storage device 22 further pre-stores at least one feature image of at least one person and expression information corresponding to each feature image. The communication module 24 is configured to receive the scene image. The analyzing module 26 is configured to analyze whether the scene image contains a preset body part. The identifying module 28 is configured to identify whether an image of the same body part of a person in the scene image as the preset body part is one of the feature images when the scene image contains the preset body part. The determining module 30 is configured to determine the expression information of the body part of the person when the image of the body part of the person is one of the feature images. The expression information of the body part will be consistent with the expression information corresponding to the identified feature image.

In one embodiment, the preset part can include a number of body parts, such as a human face and an arm. The feature image can include face images and gesture images of a number of people. The expression information includes first type expression information corresponding to the face image and second type expression information corresponding to the gesture image. The first type expression information is different from the second type of expression information. For example, the first type expression information indicates agreement or non-agreement, the second type expression information indicates interest or non-interest.

In another embodiment, the preset body part includes only one part, for example an arm. The feature image includes gesture images of a number of people. The gesture image includes a gesture indicating agreement and a gesture indicating disagreement. The agreement gesture image may be an “OK!” gesture with hand, such as thumb and index finger circled together or raised thumb and the disagreement gesture image may be crossed arms showing an X-shape. The expression information includes agreement and disagreement. The agreement of the expression information corresponds to the agreement gesture image, and the disagreement of the expression information corresponds to the disagreement gesture image.

For example, the scene image includes the “OK!”. The analyzing module 26 analyzes that the scene image includes an arm. The identifying module 28 identifies whether an image of the arm is one of the gesture images of people. Then the identifying module 28 identifies the image of the arm indicates an agreement gesture. The determining module 30 determines that the participant is expressing an information of agreement.

In another embodiment, the preset body part includes only faces. The feature image includes face images of a number of people. The face image includes facial images showing happiness and unhappiness. The expression information can include being interested and being not interested. The expression information of being interested corresponds to the facial image of happiness, and the expression information of being not interested corresponds to the facial image of the unhappiness expression.

For example, the scene image taken during a speech includes a facial image of an expression of unhappiness. The analyzing module 26 analyzes that the scene image includes a face. The identifying module 28 identifies whether an image of the face is one of pre-stored face images of people. Then the identifying module 28 identifies that the image of the face is one of pre-stored face images of the people. The determining module 30 determines that the participant is expressing an information of non-interest.

In another embodiment, the storage module 22 further pre-stores names of the people corresponding to the feature images. The determining module 30 is further determine a name of the person corresponding to the body part of the person according to the pre-stored names of the people corresponding to the feature images. The expression information further includes the name of the person.

The information transmitting system 100 further includes a statistics recording module 32. The statistics recording module 32 is configured to record a number of expression information. For example, the statistics recording module 32 records the number of “OK! s” by people in the scene.

When the image of the preset body part is identified but the person in the scene with the preset body part is not identified, the storage module 22 further stores an image of the person.

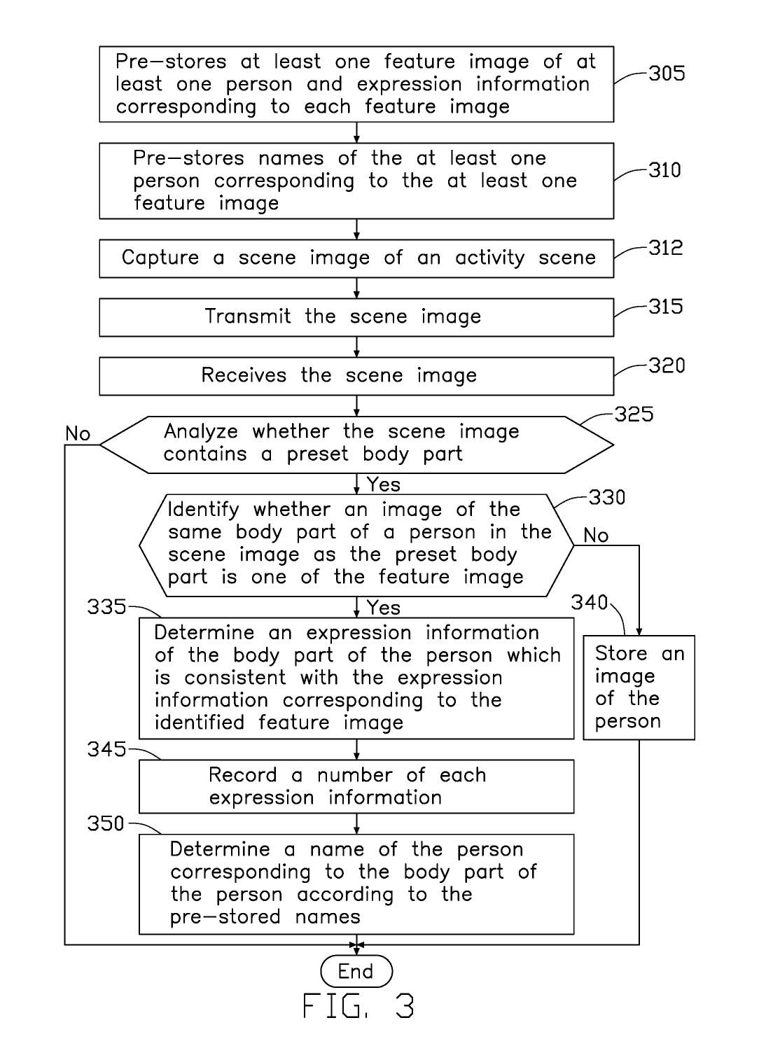

FIG. 3 illustrates a flowchart of one embodiment of an information transmitting method. The example method is provided by way of example, as there are a variety of ways to carry out the method. The method described below can be carried out using the configurations illustrated in FIG. 1, for example, and various elements of these figures are referenced in the example method. Each block shown in FIG. 3 represents one or more processes, methods, or subroutines, carried out in the method. Additionally, the illustrated order of blocks is by example only and the order of the blocks can be changed. The method can begin at block 510. Depending on the embodiment, additional steps can be added, others removed, and the ordering of the steps can be changed.

At block 305, the storage device 22 pre-stores at least one feature image of at least one person and expression information corresponding to each feature image.

In one embodiment, the feature image includes face images and gesture images of a number of people. The expression information includes first type expression information corresponding to the face image and second type expression information corresponding to the gesture image. The first type expression information is different from the second type expression information.

The face image includes a facial image of a happy expression and a facial image of an unpleasant expression. The first type of expression information includes interest and non-interest. The expression information of interest corresponds to the facial image of the happy expression, and the expression information of non-interest corresponds to the facial image of the unpleasant expression. The gesture image includes an agreement gesture image and a disagreement gesture image. The second type expression information includes agreement and disagreement. The agreement of the expression information corresponds to the agreement gesture image, and the disagreement of the expression information corresponds to the disagreement gesture image.

At block 310, the storage module 22 pre-stores names of the at least one person corresponding to the at least one feature image.

At block 312, the image acquisitioning unit 42 acquires a scene image of an activity.

At block 315, the image communication unit 44 communicates the scene image.

At block 320, the communication module 24 receives the communicated scene image.

At block 325, the analyzing module 26 analyzes whether the scene image contains a preset body part. In an embodiment, the preset body part includes face and arm. If the scene image contains the preset body part, the procedure goes to block 330, otherwise the procedure ends.

At block 330, the identifying module 28 identifies whether an image of the same body part of a person in the scene image as the preset body part is one of the feature image. If the image of the same body part of the person in the scene image as the preset body part is one of the feature images, the procedure proceeds to block 335, otherwise the procedure proceeds to 340.

At block 335, the determining module 30 determines an expression information of the body part of the person which is consistent with the expression information corresponding to the identified feature image.

At block 340, the storage module 22 stores an image of the person.

At block 345, the statistics recording module 32 records a number of each expression information.

At block 350, the determining module 30 determines a name of the person corresponding to the body part of the person according to the pre-stored names.

The embodiments shown and described above are only examples. Even though numerous characteristics and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure, up to and including the full extent established by the broad general meaning of the terms used in the claims.

What is claimed is:

1. An information transmitting method comprising:
pre-storing at least one feature image of at least one person and expression information corresponding to each feature image;
receiving a scene image;
analyzing whether the scene image contains a preset body part;
identifying whether an image of the same body part of a person in the scene image as the preset body part is one of the feature image when the scene image contains a preset body part; and
determining an expression information of the body part of the person being consistent with the expression information corresponding to the identified feature image.

2. The information transmitting method of claim 1, wherein the feature image comprises face images and gesture images of a plurality of people, the expression information comprises first type expression information corresponding to the face image and second type expression information corresponding to the gesture image.

3. The information transmitting method of claim 2, wherein the face image comprises a facial image of a happy expression and a facial image of an unpleasant expression, the first type of expression information comprises interest and non-interest, the expression information of interest corresponds to the facial image of the happy expression, and the expression information of non-interest corresponds to the facial image of the unpleasant expression.

4. The information transmitting method of claim 2, wherein the gesture image comprises an agreement gesture image and a disagreement gesture image, the second type expression information comprises agreement and disagreement, the agreement of the expression information corresponds to the agreement gesture image, and the disagreement of the expression information corresponds to the disagreement gesture image.

5. The information transmitting method of claim 1, further comprising:
pre-storing names of the at least one person corresponding to the at least one feature image; and
determining a name of the person corresponding to the body part of the person according to the pre-stored names.

6. The information transmitting method of claim 1, further comprising:
recording a number of each expression information.

7. A non-transitory storage medium having stored thereon instructions that, when executed by at least one processor, causes the processor to perform a method for transmitting information, wherein the method comprises:
pre-storing at least one feature image of at least one person and expression information corresponding to each feature image;
receiving an scene image;
analyzing whether the scene image contains a preset body part;
identifying whether an image of the same body part of a person in the scene image as the preset body part is one of the feature image when the scene image contains a preset body part; and
determining an expression information of the body part of the person being consistent with the expression information corresponding to the identified feature image.

8. The non-transitory storage medium according to claim 7, wherein the feature image comprises face images and gesture images of a plurality of people, the expression information comprises first type expression information corresponding to the face image and second type expression information corresponding to the gesture image.

9. The non-transitory storage medium according to claim 8, wherein the face image comprises a facial image of a happy expression and a facial image of an unpleasant expression, the first type of expression information comprises interest and non-interest, the expression information of interest corresponds to the facial image of the happy expression, and the expression information of non-interest corresponds to the facial image of the unpleasant expression.

10. The non-transitory storage medium according to claim 8, wherein the gesture image comprises an agreement gesture image and a disagreement gesture image, the second type expression information comprises agreement and disagreement, the agreement of the expression information corresponds to the agreement gesture image, and the disagreement of the expression information corresponds to the disagreement gesture image.

11. The non-transitory storage medium according to claim 7, the method further comprises:
pre-storing names of the at least one person corresponding to the at least one feature image; and
determining a name of the person corresponding to the body part of the person according to the pre-stored names.

12. The non-transitory storage medium according to claim 7, the method further comprises:
recording a number of each expression information.

13. An information transmitting system comprising:
at least one image acquisitioning device configured to capture a scene image of an activity scene and transmit the scene image;
an electronic device communicating with the image acquisitioning device and comprising:
a storage device that stores one or more programs, at least one feature image of at least one person and expression information corresponding to each feature image;
at least one processor; and
the one or more programs when executed by the at least one processor, cause the at least one processor to:
receive the scene image of an activity scene;
analyze whether the scene image contains a preset body part;
identify whether an image of the same body part of a person in the scene image as the preset body part is one of the feature image when the scene image contains a preset body part; and
determine an expression information of the body part of the person being consistent with the expression information corresponding to the identified feature image.

14. The information transmitting system of claim 13, wherein the feature image comprises face images and gesture images of a plurality of people, the expression information comprises first type expression information corresponding to the face image and second type expression information corresponding to the gesture image.

15. The information transmitting system of claim 14, wherein the face image comprises a facial image of a happy expression and a facial image of an unpleasant expression, the first type of expression information comprises interest and non-interest, the expression information of interest corresponds to the facial image of the happy expression, and the expression information of non-interest corresponds to the facial image of the unpleasant expression.

16. The information transmitting system of claim 14, wherein the gesture image comprises an agreement gesture image and a disagreement gesture image, the second type expression information comprises agreement and disagreement, the agreement of the expression information corresponds to the agreement gesture image, and the disagreement of the expression information corresponds to the disagreement gesture image.

17. The information transmitting system of claim 13, wherein the storage device further stores names of the at least one person corresponding to the at least one feature image, and the at least one processor is further caused to:
determine a name of the person corresponding to the body part of the person according to the pre-stored names.

18. The information transmitting system of claim 13, wherein the at least one processor is further caused to:
record a number of each expression information.

19. The information transmitting system of claim 13, wherein the information transmitting system includes a plurality of image acquisitioning devices positioned at different positions of the activity scene.

20. The information transmitting system of claim 19, wherein one of the image acquisitioning devices is positioned on the electronic device.
